(19) United States
(12) Patent Application Publication
(10) Pub. No.: US 2023/0057336 A1
(43) Pub. Date: Feb. 23, 2023

(54) LIDAR TARGET SIMULATION SYSTEM AND METHOD OF TESTING A LIDAR DEVICE

(71) Applicant: Rohde & Schwarz GmbH & Co. KG, Munich (DE)

(72) Inventors: Benedikt Simper, Munich (DE); Martin Vossiek, Munich (DE); Georg Körner, Munich (DE); Christian Carlowitz, Munich (DE); Christoph Birkenhauer, Munich (DE); Peter Tschapek, Munich (DE)

(73) Assignee: Rohde & Schwarz GmbH & Co. KG, Munich (DE)

(21) Appl. No.: 17/865,786

(22) Filed: Jul. 15, 2022

(30) Foreign Application Priority Data
Aug. 23, 2021 (EP) 21192598.7

(51) Int. Cl. G01S 17/08; G01S 7/497

(52) U.S. Cl. CPC G01S 17/08; G01S 7/497

(57) ABSTRACT

A LIDAR target simulation system for testing a LIDAR device is described. The LIDAR target simulation system includes a scenario generation circuit, a pattern detection circuit, a LIDAR simulation circuit, and a signal response generator circuit. The scenario generation circuit is configured to generate a test scenario for testing the LIDAR device. The pattern detection circuit is configured to receive at least one scan signal generated by the LIDAR device to be tested. The pattern detection circuit further is configured to determine at least one characteristic parameter of the received scan signal. The LIDAR simulation circuit is configured to simulate at least one current and/or future scan signal of the LIDAR device based on the at least one characteristic parameter. The signal response generator circuit is configured to generate a response signal to be received by the LIDAR device based on the at least one simulated scan signal of the LIDAR device and based on the test scenario. Further, a method of testing a LIDAR device by a LIDAR target simulation system is described.

### FIELD OF THE DISCLOSURE

Embodiments of the present disclosure generally relate to a LIDAR target simulation system for testing a LIDAR device. Embodiments of the present disclosure further relate to a method of testing a LIDAR device by a LIDAR target simulation system.

### BACKGROUND

LIDAR (light detection and ranging) devices such as LIDAR sensors become more and more popular in different applications, particularly in the automotive sector due to autonomous driving, also called self-driving vehicles.

Since the LIDAR devices become more and more popular in different technical fields, it is also necessary to validate and compare the different LIDAR devices concerning their respective characteristics. For a vehicle-in-the-loop test of a self-driving vehicle equipped with at least one LIDAR device, a LIDAR target simulator is necessary in order to validate the respective LIDAR device used.

Typically, a target simulator is used to test the LIDAR device while applying a certain target scenario for validating the LIDAR device. Depending on the target scenario applied, at least one target is simulated according to the respective target scenario applied.

In general, the respective target simulator receives a signal transmitted by the LIDAR device and responds with a delayed signal that corresponds to a target or rather obstacle according to the target scenario applied. The delay in time represents the distance of the target simulated.

In the state of the art, the LIDAR target simulators have an inherent minimum target distance that can be simulated, as the LIDAR target simulator is usually located a certain distance away from the LIDAR device. Moreover, the LIDAR target simulator needs a certain time in order to process the received signal transmitted by the LIDAR device in order to generate the response signal, thereby increasing the minimum distance that can be simulated.

Thus, the minimum distance that can be simulated is given by the distance between the LIDAR device and the LIDAR target simulator and by the processing time of the LIDAR target simulator.

Thus, it is desirable to reduce the minimum possible target distance that can be simulated.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present disclosure provide a LIDAR target simulation system for testing a LIDAR device. In an embodiment, the LIDAR target simulation system comprises a scenario generation circuit, a pattern detection module, a LIDAR simulation circuit, and a signal response generator. The scenario generation circuit is configured to generate a test scenario for testing the LIDAR device. The pattern detection module, which, inter alia, may include one or more circuits, is configured to receive at least one scan signal generated by the LIDAR device to be tested, and to determine at least one characteristic parameter of the received scan signal. The at least one characteristic parameter is associated with properties of the at least one scan signal. The LIDAR simulation circuit is configured to simulate at least one current and/or future scan signal of the LIDAR device based on the at least one characteristic parameter. The signal response generator is configured to generate a response signal to be received by the LIDAR device to be tested, wherein the signal response generator is configured to generate the response signal based on the at least one simulated scan signal of the LIDAR device and based on the test scenario.

The LIDAR target simulation system is based on the idea to predict a future behavior of the LIDAR device to be tested based on an analysis of at least one scan signal of the LIDAR device in order to reduce the minimum possible target distance that can be simulated.

In other words, a digital twin of the LIDAR device may be provided, wherein the digital twin of the LIDAR device corresponds to a simulation of the LIDAR device or of the scan signals generated by the LIDAR device. The response signal is generated based on the current and/or future behavior of the digital twin, namely based on the at least one simulated current and/or future scan signal of the LIDAR device, instead of the actual (i.e. real) current and/or future scan signal(s) generated by the LIDAR device to be tested.

Based on the predicted future behavior, a response signal to a further scan signal of the LIDAR device to be tested may be generated before that further scan signal even arrives at the pattern detection module. Thus, with embodiments of the present application, the distance between the LIDAR device to be tested and the pattern detection module is not a delimiting factor for simulating targets.

In some embodiments, targets that are closer than the distance between the LIDAR device to be tested and the pattern detection module can be simulated by the LIDAR target simulation system.

Moreover, the processing time of the LIDAR target simulation system can also be accounted for or compensated by the LIDAR target simulation system. The generated response signal may be time-shifted in order to compensate the processing time of the LIDAR target simulation system. Thus, the minimum possible simulation distance is reduced even further.

In some embodiments, it is even possible to reduce the minimum target simulation distance to 0 with the LIDAR target simulation system according to the present disclosure.

According to an aspect of the present disclosure, the at least one characteristic parameter comprises, for example, a pulse shape of the at least one scan signal, an angle of departure of the at least one scan signal, a time of detection of the at least one scan signal, pulse rate of the at least one scan signal, a pulse position of the at least one scan signal, a line rate of the at least one scan signal, a column rate of the at least one scan signal, and/or a repetition rate of the at least one scan signal.

Therein and in the following, the term “pulse shape” may relate to the size, the geometric cross section and/or the temporal course of the amplitude of a single pulse of the scan signal.

The “angle of departure” may relate to the azimuth and/or the elevation angle of the at least one scan signal with respect to the LIDAR device.

The term “pulse rate” relates to the number of light pulses that are generated by the LIDAR device to be tested per second.

The term “pulse position” relates to the position or rather the positions of the light pulses generated by the LIDAR device to be tested, for example the location on a screen of the LIDAR target simulation system. In some embodiments, the term “pulse positions” is understood to include a scan pattern, wherein the scan pattern relates to the temporal course of the positions of the light pulses generated by the LIDAR device to be tested, for example the temporal course of the respective locations on the screen.

The term “line rate” relates to the number of lines that the LIDAR device to be tested scans per second.

The term “column rate” relates to the number of columns that the LIDAR device to be tested scans per second.

The term “repetition rate” is understood to denote the rate at which the LIDAR device completes whole scans of its environment, i.e. the rate at which a predetermined scan pattern of the LIDAR device to be tested repeats. The repetition rate may also be called “frame rate” of the LIDAR device.

Generally, only a portion of the entire environment may be scanned.

In some embodiments, the certain portion of the entire environment may relate to the field of view of the LIDAR device.

According to another aspect of the present disclosure, the LIDAR simulation circuit is configured to simulate, for example, the at least one current and/or future scan signal of the LIDAR device based on a state space model of the LIDAR device. In general, the state space model of the LIDAR device employs a mathematical model of the LIDAR device that comprises all parameters, for example the at least one characteristic parameter described above, that are necessary in order to describe the temporal course of scan signals generated by the LIDAR device. Thus, in principle, if the state of the LIDAR device is known at one point in time, then the future behavior of the LIDAR device, i.e. future scan signals generated by the LIDAR device, can be predicted based on the state space model.

In an embodiment, the LIDAR simulation circuit comprises a Kalman filter and/or a machine-learning circuit, wherein the Kalman filter and/or the machine-learning circuit is configured to simulate the at least one current and/or future scan signal of the LIDAR device based on the state space model of the LIDAR device.

In general, the Kalman filter may be configured to determine relevant parameters of the state space model based on available parameters, i.e. parameters that have been measured and/or determined. For example, one or several of the characteristic parameters described above may be measured and/or determined by the pattern detection module. The Kalman filter may determine missing parameters of the state space model based on the measured and/or determined parameters, for example based on the at least one characteristic parameter.

Similarly, the machine-learning circuit may be trained to determine relevant parameters of the state space model based on available parameters. For example, one or several of the characteristic parameters described above may be measured by the pattern detection module. The machine-learning circuit may determine missing parameters of the state space model based on the measured parameters, for example based on the at least one characteristic parameter.

In some embodiments, the pattern detection module is configured to receive at least one further scan signal generated by the LIDAR device during testing of the LIDAR device, wherein the pattern detection module further is configured to determine at least one updated characteristic parameter of the LIDAR device based on the at least one further scan signal, and wherein the LIDAR simulation circuit is configured to update parameters of the state space model based on the at least one updated characteristic parameter. In other words, the state space model may be continuously updated based on current measurements of the scan signals generated by the LIDAR device to be tested. This way, it is ensured that errors in the state space model or rather in the determined state of the LIDAR device do not accumulate to large errors in the simulated scan signals.

In some embodiments, the LIDAR simulation circuit is configured to update the parameters of the state space model by a closed-loop control technique. According to the closed-loop control technique, the parameters of the state space model are predicted or rather determined by the LIDAR simulation circuit. New measurement data with respect to the current scan signal(s) generated by the LIDAR device, for example one or several updated characteristic parameters, is obtained. The parameters of the state space model are corrected based on the obtained measurement data, for example based on the one or several updated characteristic parameters.

According to other embodiments, the signal response generator comprises an analog pulse responder configured to generate the response signal to be received by the LIDAR device. The analog pulse responder may comprise a detection circuit configured to detect the at least one scan signal generated by the LIDAR device to be tested. The analog pulse response may be configured to autonomously generate the response signal based on the detected scan signal. The response signal may be generated with a predefined delay, wherein the predefined delay may be set based on the scenario and/or based on the at least one simulated scan signal.

According to an aspect of the present disclosure, the analog pulse responder comprises, for example, an analog integrator including, inter alia, circuitry configured to integrate a constant voltage signal, thereby obtaining an integrated voltage signal, and configured to generate the response signal when the integrated voltage signal reaches a predefined threshold. In some embodiments, the constant voltage signal may be integrated over time. A value of the integrated voltage signal may be compared to the predefined threshold continuously or after predetermined time intervals. This way, the response signal is generated with a predetermined delay, wherein the predetermined delay depends on the magnitudes of the constant voltage signal and of the predefined threshold.

According to a further aspect of the present disclosure, the signal response generator is configured, for example, to adjust a magnitude of the constant voltage signal and/or the predefined threshold based on the at least one simulated scan signal of the LIDAR device and/or based on the test scenario. In other words, the signal response generator may set a predetermined delay of the response signal by adjusting the magnitude of the constant voltage signal and/or the predefined threshold based on the at least one simulated scan signal of the LIDAR device and/or based on the test scenario, such that the response signal is correctly generated for the specific test scenario at hand.

The analog integrator may be configured to start integrating the constant voltage signal upon detection of the at least one scan signal. This way, it is avoided that a response signal is generated although a corresponding scan signal of the LIDAR device is missing. Moreover, a correct response signal is generated even on the case of the scan signals generated by the LIDAR device comprising jitter.

Moreover, the required sampling rate of, for example, the pattern detection module and/or the LIDAR simulation circuit of the LIDAR target simulation system can be lowered significantly as the temporal resolution of the detection and response generation no longer depends on the input/output rate of the digital circuitry. This allows for using more cost-efficient hardware for the digital circuitry, thereby reducing the costs of the LIDAR target simulation system.

Moreover, a higher resolution is obtainable with respect to setting the delay after which the response signal is generated.

In an embodiment, the signal response generator including, inter alia, circuitry configured to generate the response signal with a predetermined time delay, for example wherein the predetermined time delay depends on the at least one simulated scan signal of the LIDAR device and/or on the test scenario. In general, the predetermined time delay causes the LIDAR device to be tested to receive the response signal with the predetermined time delay plus the travel time of the response signal from the signal response generator to the LIDAR device. This way, objects can be simulated that have a predetermined distance from the LIDAR device. Thus, the test scenario may comprise one or several targets and/or obstacles that each have a predefined distance from the LIDAR device, wherein the individual distances may be pairwise equal and/or different from each other.

According to another embodiment of the present disclosure, the test scenario is a three-dimensional test scenario and/or wherein the test scenario comprises at least one object, wherein a simulated distance of the at least one object is smaller than a length corresponding to the speed of light times a processing time of the signal response generator.

The three-dimensional test scenario may comprise one or several three-dimensional targets and/or one or several three-dimensional obstacles. Thus, a realistic testing scenario may be provided for testing the LIDAR device.

Alternatively or additionally, at least one simulated object, for example at least one simulated target and/or at least one simulated obstacle, may have a simulated distance that is smaller than what is achievable with conventional LIDAR target simulation systems, as the simulated distance is smaller than the distance light travels within the processing time of the signal response generator. This is achievable as the response signal may already be generated based on the simulated scan signal while the respective actual (i.e. real) scan signal of the LIDAR device under test is still travelling towards the pattern recognition module.

Therein and in the following, the term “processing time of the signal response generator” is understood to denote the time needed to generate the response signal based on the simulated scan signals of the LIDAR device and based on the test scenario.

Optionally, the processing time of the signal response generator may also include the time needed by the pattern detection module in order to receive and process the at least one scan signal.

In another embodiment of the present disclosure, the LIDAR device is a flash LIDAR device. In general, flash LIDAR devices illuminate the whole environment to be scanned at once instead of scanning the environment with a pattern or rather raster of individual smaller light pulses. Accordingly, characteristic parameters associated with the flash LIDAR device may be the pulse shape of the scan signal, the angle of departure of the scan signal, the pulse rate of the scan signal and the repetition rate (frame rate) of the scan signal, wherein the pulse rate is equal to the repetition rate (frame rate).

Embodiments of the present disclosure further provide a method of testing a LIDAR device by a LIDAR target simulation system. In an embodiment, the method comprises the following steps:

generating a test scenario for testing the LIDAR device by a scenario generation circuit;

receiving at least one scan signal generated by the LIDAR device by a pattern detection module;

determining at least one characteristic parameter of the received scan signal by the pattern detection module, wherein the at least one characteristic parameter is associated with properties of the at least one scan signal;

simulating at least one current and/or future scan signal of the LIDAR device based on the at least one characteristic parameter by a LIDAR simulation circuit; and

generating a response signal to be received by the LIDAR device by a signal response generator, wherein the signal response generator is configured to generate the response signal based on the at least one simulated scan signal of the LIDAR device and based on the test scenario.

In some embodiments, the LIDAR target simulation system described above is configured to perform any one of the methods of testing a LIDAR device described herein.

Regarding the advantages and further properties of the method(s) of testing a LIDAR device, reference is made to the explanations given above with respect to the LIDAR target simulation system, which also hold for the method(s) of testing a LIDAR device and vice versa.

According to another aspect of the present disclosure, the at least one current and/or future scan signal of the LIDAR device is simulated based on a state space model of the LIDAR device. In general, the state space model of the LIDAR device employs a mathematical model of the LIDAR device that comprises one or more of, or all of, the parameters, for example the at least one characteristic parameter described above, that are suitable in order to describe the temporal course of scan signals generated by the LIDAR device. Thus, in principle, if the state of the LIDAR device is known at one point in time, then the future behavior of the LIDAR device, i.e. future scan signals generated by the LIDAR device, can be predicted based on the state space model.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a LIDAR target simulation system according to one or more aspects of the present disclosure;

FIG. 2 shows a block diagram of the LIDAR target simulation system of FIG. 1 according to a first embodiment of the disclosure; and

FIG. 3 shows a block diagram of the LIDAR target simulation system of FIG. 1 according to a second embodiment of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

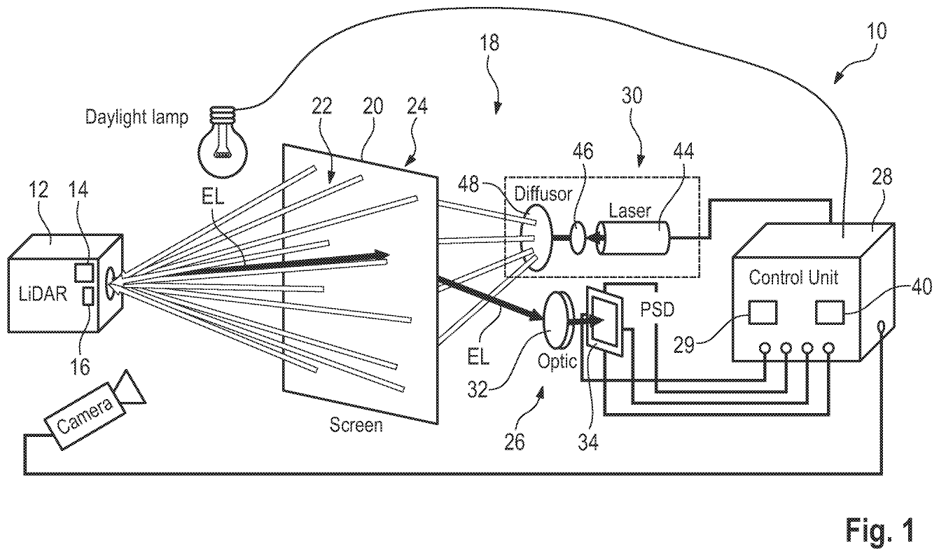

FIG. 1 schematically shows a LIDAR target simulation system 10 for testing a LIDAR device 12. In general, the LIDAR target simulation system 10 is configured to receive scan signals (denoted by “EL” in FIG. 1) generated by the LIDAR device 12. The LIDAR target simulation system 10 generates an appropriate response signal based on the scan signal received from the LIDAR device 12 and based on a test scenario, such that one or more objects such as targets and/or obstacles are simulated for testing the LIDAR device 12.

The LIDAR device 12 has a light emitting unit 14 as well as a light receiving unit 16. The light emitting unit 14 and the light receiving unit 16 are integrated within a housing of the LIDAR device 12. In some embodiments, the LIDAR device 12, or components thereof, such as the light emitting unit 14 and/or the light receiving unit 16 may include one or more of the following components: a Laser, phased arrays of antennas, electromechanical mirrors, scanners and optics (e.g., mirrors, lens, etc.,), photosensors, other sensors, etc.

Further, the LIDAR simulation system 10 comprises a LIDAR target simulator 18 that interacts with the LIDAR device 12 in order to evaluate the LIDAR device 12 by simulating a respective target (scenario) for the LIDAR device 12 for evaluating purposes.

In the embodiment shown, the LIDAR target simulator 18 comprises a screen 20 that has a front side 22 as well as a rear side 24 that is opposite to the front side 22. The LIDAR target simulator 18 further comprises a pattern detection module 26 that is connected with a control and/or analysis circuit 28 in a signal transmitting manner. In some embodiments, the pattern detection module 26 includes, inter alia, circuitry.

The pattern detection module 26 may be partially integrated into the control and/or analysis circuit 28. Alternatively, the pattern detection module 26 may be established separately from the control and/or analysis circuit 28. In some embodiments, circuitry of the pattern detection module 26 and/or the control and/or analysis circuit 28 may include, for example, suitable hardware, suitable software, or a combination of hardware and software that is configured to carry out the technologies and methodologies of the present disclosure. The hardware may, inter alia, comprise a CPU, a GPU, an FPGA, an ASIC, or other types of electronic circuitry.

Therein and in the following, the term “connected in a signal transmitting manner” is understood to denote a cable-based or wireless connection that is configured to transmit signals between the respective devices or components.

Further, the LIDAR target simulator 18 includes a LIDAR simulation circuit 29 and a signal response generator 30 that are also connected with the control and/or analysis circuit 28 in a signal transmitting manner Among other things, the signal response generator 30 may include, for example, one or more circuits for carrying out the methodologies and technologies thereof.

As is shown in FIG. 1, the LIDAR simulation circuit 29 may be partially or completely integrated into the control and/or analysis circuit 28. Alternatively, the LIDAR simulation circuit 29 may be established separately from the control and/or analysis circuit 28.

Moreover, the signal response generator 30 may be partially integrated into the control and/or analysis circuit 28. Alternatively, the signal response generator 30 may be established separately from the control and/or analysis circuit 28.

In general, the pattern detection module 26 is configured to determine the location of impinging light generated by the LIDAR device 12, namely of a scan signal generated by the LIDAR device 12, which hits the screen 20, for example the front side 22 of the screen 20.

The pattern detection module 26 forwards information concerning the respective location to the control and/or analysis circuit 28 and to the LIDAR simulation circuit 29 for further processing.

In the shown embodiment, the pattern detection module 26 also includes an optical element 32, namely an optic, which faces the screen 20, for example the rear side 24 of the screen 20 in the shown embodiment. The optical element 32 is also associated with a position sensitive detector (PSD) 34 of the pattern detection circuit 26.

Hence, the optical element 32 focuses the light available on the rear side 24 of the screen 20 that is at least partially transparent for the light used for testing the LIDAR device 12 such that the position sensitive detector 34 is enabled to determine the location of the impinging light on the screen 20, i.e. of the scan signal(s), in an accurate manner

The position sensitive detector 34 forwards at least a respective signal to the control and/or analysis circuit 28 and to the LIDAR simulation circuit 29, wherein the signal encompasses the information concerning the location of the scan signal(s) on the screen 20.

The pattern detection module 26 is also configured to determine at least one characteristic parameter of the scan signal. In general, the at least one characteristic parameter is associated with properties of the at least one scan signal.

In some embodiments, the at least one characteristic parameter comprises a pulse shape of the at least one scan signal, an angle of departure of the at least one scan signal, a time of detection of the at least one scan signal, pulse rate of the at least one scan signal, a pulse position of the at least one scan signal, a line rate of the at least one scan signal, a column rate of the at least one scan signal, and/or a repetition rate of the at least one scan signal.

Therein and in the following, the term “pulse shape” may relate to the size, the geometric cross section and/or the temporal course of the amplitude of a single pulse of the scan signal.

The “angle of departure” may relate to the azimuth and/or the elevation angle of the at least one scan signal with respect to the LIDAR device 12.

The term “pulse rate” relates to the number of light pulses that are generated by the LIDAR device 12 to be tested per second.

The term “pulse position” relates to the position or rather the positions of the light pulses generated by the LIDAR device 12 to be tested, for example the location on the screen 20.

In some embodiments, the term “pulse positions” is understood to include a scan pattern, wherein the scan pattern relates to the temporal course of the positions of the light pulses generated by the LIDAR device 12 to be tested, namely the temporal course of the respective locations on the screen 20.

The term “line rate” relates to the number of lines that the LIDAR device 12 scans per second.

The term “column rate” relates to the number of columns that the LIDAR device 12 scans per second.

The term “repetition rate” is understood to denote the rate at which the LIDAR device 12 completes whole scans of its environment, i.e. the rate at which a predetermined scan pattern of the LIDAR device 12 repeats. The repetition rate may also be called “frame rate” of the LIDAR device 12.

The pattern detection module 26 forwards the at least one determined characteristic parameter to the control and/or analysis circuit 28 and to the LIDAR simulation circuit 29.

The LIDAR simulation circuit 29 is configured to simulate at least one current and/or future scan signal of the LIDAR device 12 based on the at least one characteristic parameter determined by the pattern detection circuit 26.

In other words, a digital twin of the LIDAR device 12 may be provided by the LIDAR simulation circuit 29, wherein the digital twin of the LIDAR device 12 corresponds to a simulation of the LIDAR device 12.

The LIDAR simulation circuit 29 may simulate the at least one current and/or future scan signal of the LIDAR device 12 based on a state space model of the LIDAR device 12.

In general, the state space model of the LIDAR device 12 employs a mathematical model of the LIDAR device 12 that comprises all necessary parameters in order to describe current and/or future scan signals generated by the LIDAR device 12. In some embodiments, the parameters of the state space model comprise the at least one characteristic parameter described above.

Thus, in principle, if the state of the LIDAR device 12 is exactly known at one point in time, then the future behavior of the LIDAR device 12, i.e. future scan signals generated by the LIDAR device, can be predicted based on the state space model for all times. However, this would require perfect knowledge of all parameters of the state space model at a single given time.

In practice, the current state of the LIDAR device 12 is usually not known perfectly, such that a perfect prediction of the future behavior of the LIDAR device 12 is not possible based on a state determined for a single given time. Moreover, usually not all parameters of the state space model can be measured directly or only with considerable more effort.

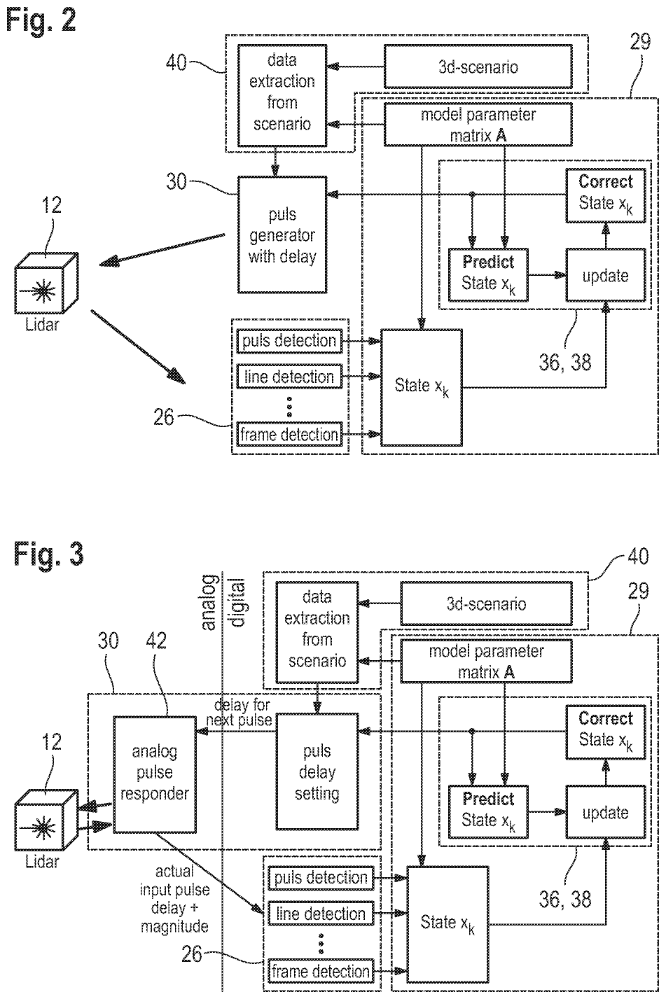

As is illustrated in FIG. 2, in order to counteract this problem, the LIDAR simulation circuit 29 comprises a Kalman filter 36 and/or a machine-learning circuit 38 that are part of a closed control loop in order to determine the state of the LIDAR device 12.

In some embodiments, the LIDAR simulation circuit 29 may continuously update the parameters of the state space model by a closed-loop control technique.

The closed-loop control technique may comprise the following steps.

The parameters of the state space model are predicted by the LIDAR simulation circuit 29 based on a first measurement of the at least one characteristic parameter described above. The parameters may comprise the at least one characteristic parameter determined by the pattern detection circuit 26.

The parameters may be conflated in a model parameter matrix, which is called “model parameter matrix A” in FIG. 2.

This step may be performed only once, while the two steps described in the following may be repeated several times.

If there are parameters of the state space model that cannot be measured, the Kalman filter 36 and/or the machine-learning circuit 38 may determine the missing parameters based on the available parameters.

Therein, the Kalman filter 36 may employ a mathematical model of the LIDAR device 12 in order to determine the missing parameters based on the available parameters. Alternatively or additionally, the machine-learning circuit 38 may be trained to determine the missing parameters based on the available parameters.

During testing of the LIDAR device 12, new measurement data with respect to the current scan signal(s) generated by the LIDAR device 12 may be obtained after predefined time intervals, for example continuously. In some embodiments, the pattern detection circuit 26 may determine updated characteristic parameters based on at least one further scan signal generated by the LIDAR device 12, for example based on several further scan signals generated by the LIDAR device 12.

The parameters of the state space model are corrected based on the obtained measurement data, for example based on the one or several updated characteristic parameters. In some embodiments, the parameters that are not available may be corrected by the Kalman filter 36 and/or by the machine-learning circuit 38.

The LIDAR simulation circuit 29 may forward the at least one simulated scan signal to the control and/or analysis circuit 28.

Further, the LIDAR target simulator 18 has a scenario generation circuit 40 that generates a test scenario for testing the LIDAR device 12.

As is shown in FIG. 1, the scenario generation circuit 40 may be partially or completely integrated into the control and/or analysis circuit 28. Alternatively, the scenario generation circuit 40 may be established separately from the control and/or analysis circuit 28.

It is noted that the scenario generation circuit 40 may be completely independent of the LIDAR simulation circuit 29. In other words, the generated test scenario may not be correlated with the simulated scan signal(s) and vice versa.

The test scenario may be a three-dimensional test scenario. The three-dimensional test scenario may comprise one or several three-dimensional targets and/or one or several three-dimensional obstacles, such that a realistic testing scenario is provided for testing the LIDAR device 12.

Alternatively or additionally, the test scenario may comprise at least one object whose simulated distance from the LIDAR device 12 is smaller than a length corresponding to the speed of light times a processing time of the signal response generator module 30.

Therein and in the following, the term “processing time of the signal response generator” is understood to denote the time needed to generate the response signal based on the simulated scan signals of the LIDAR device 12 and based on the test scenario, as will be described hereinafter.

Optionally, the processing time of the signal response generator 30 may also include the time needed by the pattern detection module 26 in order to receive and process the at least one scan signal generated by the LIDAR device 12.

The scenario generation circuit forwards the generated test scenario to the control and/or analysis circuit 28. The control and/or analysis circuit 28 causes the signal response generator 30 to generate a response signal for the LIDAR device 12.

Therein, the control and/or analysis circuit 28 takes the generated test scenario and the simulated scan signal(s) into account. In other words, the control and/or analysis circuit 28 controls the signal response generator 30 to generate a suitable response signal for the LIDAR device 12 based on the generated test scenario and based on the simulated scan signal(s).

In some embodiments, the control and/or analysis circuit 28 controls the signal response generator 30 to generate the response signal(s) with a predetermined time delay with respect to the simulated scan signal(s), such that the objects (e.g. targets and obstacles) in the test scenario are correctly simulated for the LIDAR device 12.

With the LIDAR target simulation system 10 described above, a response signal that corresponds to a further scan signal of the LIDAR device 12 may be generated before that further scan signal even arrives at the pattern detection module 26. Thus, the distance between the LIDAR device 12 and the pattern detection module 26 is not a delimiting factor for simulating targets.

In some embodiments, targets that are closer than the distance between the LIDAR device 12 and the pattern detection module 26 can be simulated by the LIDAR target simulation system 10 described above.

Moreover, the processing time of the LIDAR target simulation system 10 can also be accounted for or rather compensated by the LIDAR target simulation system 10 described above. The generated response signal may be time-shifted in order to compensate for the processing time of the LIDAR target simulation system 10. Thus, the minimum possible simulation distance is reduced even further.

In some embodiments, it is even possible to reduce the minimum target simulation distance to 0 with the LIDAR target simulation system 10 described above.

In some embodiments, the LIDAR device 12 may be established as a flash LIDAR device. In general, flash LIDAR devices illuminate the whole environment to be scanned at once instead of scanning the environment with a pattern or raster of individual smaller light pulses. Accordingly, characteristic parameters associated with the flash LIDAR device 12 may be the pulse shape of the scan signal, the angle of departure of the scan signal, the pulse rate of the scan signal and the repetition rate (frame rate) of the scan signal, wherein the pulse rate is equal to the repetition rate (frame rate).

Apart from these differences, the explanations given above also apply to the case of the LIDAR device 12 being established as a flash LIDAR device 12.

FIG. 3 shows a second embodiment of the LIDAR target simulation system 10, wherein only the differences compared to the first embodiment described above are described hereinafter.

In the shown embodiment, the signal response generator 30 comprises an analog pulse responder 42. In general, the analog pulse responder 42 is configured to autonomously generate the response signal to be received by the LIDAR device. The analog pulse responder 42 may comprise a detection circuit configured to detect the at least one scan signal generated by the LIDAR device 12.

Upon detection of a scan signal generated by the LIDAR device 12, the analog pulse responder 42 starts integrating a constant voltage signal over time. The analog pulse responder 42 compares a value of the integrated voltage signal with a predefined threshold continuously or after predetermined time intervals. The analog pulse responder 42 generates the response signal when the integrated voltage signal reaches a predefined threshold. This way, the response signal is generated with a predetermined delay, wherein the predetermined delay depends on the magnitude of the constant voltage signal and on the magnitude of the predefined threshold.

The signal response generator 30 may be controlled by the control and/or analysis circuit 28 to adjust a magnitude of the constant voltage signal and/or the magnitude of the predefined threshold based on the at least one simulated scan signal of the LIDAR device 12 and/or based on the test scenario.

Thus, the predetermined delay can be adjusted by adjusting the magnitude of the of the constant voltage signal and/or the magnitude of the predefined threshold, such that the targets and/or obstacles in the test scenario are correctly simulated for the LIDAR device 12.

Irrespective of the embodiment, the response signal may be generated by the signal response signal generator 30 via a laser 44, an attenuator 46, and a diffusor 48.

For instance, the laser 44 may be controlled such that the response signal is modulated concerning its intensity in an appropriate manner depending on the respective target scenario applied. In a similar manner, the attenuator 46 may be controlled appropriately by the control and/or analysis circuit 28 such that the response signal provided by the signal response generator 30 is attenuated depending on the target scenario applied. The diffusor 48 may also be controlled such that the response signal is diffused in a controlled manner.

In general, the response signal may be generated in any way that is suitable such that the test scenario is correctly simulated for the LIDAR device 12. In some embodiments, the response signal is projected on the rear side 24 of the screen, and the LIDAR device 12 captures the light shining through the screen 20 by the light receiving unit 16.

Suitable examples of how the response signal may be generated are described in European patent application number EP20184311.7, the disclosure of which is expressly incorporated by reference.

Certain embodiments disclosed herein utilize circuitry (e.g., one or more circuits), including any one of the circuits mentioned above, in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof.

In an embodiment, circuitry includes hardware circuit implementations (e.g., implementations in analog circuitry, implementations in digital circuitry, and the like, and combinations thereof). In an embodiment, circuitry includes combinations of hardware circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors, such as, for example, microprocessors, or portions thereof and accompanying software, firmware, hardware, and the like.

In some examples, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A LIDAR target simulation system for testing a LIDAR device, the LIDAR target simulation system comprising a scenario generation circuit, a pattern detector, a LIDAR simulation circuit, and a signal response generator,
wherein the scenario generation circuit is configured to generate a test scenario for testing the LIDAR device,
wherein the pattern detector includes circuitry configured to receive at least one scan signal generated by the LIDAR device to be tested, wherein the pattern detector further includes circuitry configured to determine at least one characteristic parameter of the received scan signal, wherein the at least one characteristic parameter is associated with properties of the at least one scan signal,
wherein the LIDAR simulation circuit is configured to simulate at least one current and/or future scan signal of the LIDAR device based on the at least one characteristic parameter, and
wherein the signal response generator includes circuitry configured to generate a response signal to be received by the LIDAR device to be tested, wherein the signal response generator includes circuitry configured to generate the response signal based on the at least one simulated scan signal of the LIDAR device and based on the test scenario.

2. The LIDAR target simulation system according to claim 1, wherein the at least one characteristic parameter comprises a pulse shape of the at least one scan signal, an angle of departure of the at least one scan signal, a time of detection of the at least one scan signal, pulse rate of the at least one scan signal, a pulse position of the at least one scan signal, a line rate of the at least one scan signal, a column rate of the at least one scan signal, and/or a repetition rate of the at least one scan signal.

3. The LIDAR target simulation system according to claim 1, wherein the LIDAR simulation circuit is configured to simulate the at least one current and/or future scan signal of the LIDAR device based on a state space model of the LIDAR device.

4. The LIDAR target simulation system according to claim 3, wherein the LIDAR simulation circuit comprises a Kalman filter and/or a machine-learning circuit, wherein the Kalman filter and/or the machine-learning circuit is configured to simulate the at least one current and/or future scan signal of the LIDAR device based on the state space model of the LIDAR device.

5. The LIDAR target simulation system according to claim 3, wherein the pattern detector includes circuitry configured to receive at least one further scan signal generated by the LIDAR device during testing of the LIDAR device, wherein the pattern detector further includes circuitry configured to determine at least one updated characteristic parameter of the LIDAR device based on the at least one further scan signal, and wherein the LIDAR simulation circuit is configured to update parameters of the state space model based on the at least one updated characteristic parameter.

6. The LIDAR target simulation system according to claim 5, wherein the LIDAR simulation circuit is configured to update the parameters of the state space model by a closed-loop control technique.

7. The LIDAR target simulation system according to claim 1, wherein the signal response generator comprises an analog pulse responder, and wherein the analog pulse responder includes circuitry configured to generate the response signal to be received by the LIDAR device.

8. The LIDAR target simulation system according to claim 7, wherein the analog pulse responder comprises an analog integrator, wherein the analog integrator includes circuitry configured to integrate a constant voltage signal, thereby obtaining an integrated voltage signal, and wherein the analog pulse responder includes circuitry configured to generate the response signal when the integrated voltage signal reaches a predefined threshold.

9. The LIDAR target simulation system of claim 8, wherein the signal response generator includes circuitry configured to adjust a magnitude of the constant voltage signal and/or the predefined threshold based on the at least one simulated scan signal of the LIDAR device and/or based on the test scenario.

10. The LIDAR target simulation system of claim 8, wherein the analog integrator includes circuitry configured to start integrating the constant voltage signal upon detection of the at least one scan signal.

11. The LIDAR target simulation system according to claim 1, wherein the signal response generator includes circuitry configured to generate the response signal with a predetermined time delay.

12. The LIDAR target simulation system according to claim 11, wherein the predetermined time delay depends on the at least one simulated scan signal of the LIDAR device and/or on the test scenario.

13. The LIDAR target simulation system according to claim 1, wherein the test scenario is a three-dimensional test scenario and/or wherein the test scenario comprises at least one object, wherein a simulated distance of the at least one object is smaller than a length corresponding to the speed of light times a processing time of the signal response generator.

14. The LIDAR target simulation system according to claim 1, wherein the LIDAR device is a flash LIDAR device.

15. A method of testing a LIDAR device by a LIDAR target simulation system, the method comprising the following steps:
generating a test scenario for testing the LIDAR device by a scenario generation circuit;
receiving at least one scan signal generated by the LIDAR device by a pattern detector;
determining at least one characteristic parameter of the received scan signal by circuitry of the pattern detector, wherein the at least one characteristic parameter is associated with properties of the at least one scan signal;
simulating at least one current and/or future scan signal of the LIDAR device based on the at least one characteristic parameter by a LIDAR simulation circuit; and
generating a response signal to be received by the LIDAR device by a signal response generator, wherein the signal response generator includes circuitry configured to generate the response signal based on the at least one simulated scan signal of the LIDAR device and based on the test scenario.

16. The method of claim 15, wherein the at least one current and/or future scan signal of the LIDAR device is simulated based on a state space model of the LIDAR device.
